(19) United States
(12) Patent Application Publication
(10) Pub. No.: US 2011/0241510 A1
(43) Pub. Date: Oct. 6, 2011

(54) Easy No Tool Assembly Cabinet

(76) Inventor: Shih-Ming Lin, Dongguan City (CN)

(21) Appl. No.: 12/754,960

(22) Filed: Apr. 6, 2010

(51) Int. Cl. A47B 88/04; A47B 96/00; F16M 13/02; A47B 95/00

(52) U.S. Cl. 312/309; 248/201

(57) ABSTRACT

A cabinet assembly includes a cabinet and a bottom frame mounted on the bottom of the cabinet. The cabinet includes a bottom board, a plurality of connecting boards detachably mounted on the bottom board, a top board detachably mounted on the connecting boards, a rear board detachably mounted between two of the connecting boards, a plurality of drawers detachably mounted between the connecting boards, and two front panels detachably mounted on two of the connecting boards respectively. The bottom frame includes two support brackets and two connecting sleeves mounted between the two support brackets. Thus, each of the cabinet and the bottom frame is assembled and disassembled so that the cabinet assembly can be assembled and disassembled easily and conveniently without using hand tools, thereby facilitating a user assembling and disassembling the cabinet assembly.

### BACKGROUND OF THE INVENTION

1. Field of the Invention

The present invention relates to a furniture or storage unit and, more particularly, to an easy no tool assembly cabinet.

2. Description of the Related Art

A conventional cabinet assembly usually comprises a plurality of connecting boards which are connected with each other by a plurality of locking members, such as screws, bolts, nuts, nails and the like. However, a user needs to use a hand tool, such as the screwdriver, hammer and the like, to drive the locking members so as to combine the connecting boards so that the cabinet assembly cannot be assembled easily and quickly, thereby causing inconvenience to the user when assembling the cabinet assembly. In addition, the cabinet assembly has a larger volume to increase the cost of packaging, transportation and storage of the cabinet assembly.

### BRIEF SUMMARY OF THE INVENTION

In accordance with the present invention, there is provided a cabinet assembly, comprising a cabinet including a bottom board, a plurality of upright connecting boards detachably mounted on the bottom board, a top board detachably mounted on the connecting boards which are located between the bottom board and the top board, a rear board detachably mounted between two of the connecting boards and located between the bottom board and the top board, a plurality of drawers detachably mounted between the connecting boards, and two front panels pivotally and detachably mounted on two of the connecting boards respectively and located between the bottom board and the top board.

The cabinet assembly further comprises a bottom frame mounted on a bottom of the cabinet to support the cabinet. The bottom frame includes two substantially inverted U-shaped support brackets and two connecting sleeves mounted between the two support brackets.

The primary objective of the present invention is to provide a cabinet assembly that is assembled and disassembled easily and quickly without needing aid of any hand tool.

According to the primary objective of the present invention, each of the cabinet and the bottom frame is assembled and disassembled individually so that the cabinet assembly can be assembled and disassembled easily and conveniently without using hand tools, thereby facilitating a user assembling and disassembling the cabinet assembly.

According to another objective of the present invention, each of the cabinet and the bottom frame can be detached completely so that the cabinet assembly has the minimum volume before assembly so as to decrease the cost of packaging, transportation and storage of the cabinet assembly.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a cabinet assembly in accordance with the preferred embodiment of the present invention.

FIG. 2 is a partially exploded perspective view of the cabinet assembly as shown in FIG. 1.

FIG. 3 is a locally enlarged view of the cabinet assembly as shown in FIG. 2.

FIG. 4 is a partially side exploded cross-sectional view of the cabinet assembly as shown in FIG. 3.

FIG. 5 is a schematic operational view of the cabinet assembly as shown in FIG. 4 in assembly.

FIG. 6 is a schematic operational view of the cabinet assembly as shown in FIG. 5 in assembly.

FIG. 7 is a perspective view of a drawer of the cabinet assembly as shown in FIG. 2.

FIG. 8 is a partially exploded perspective view of the drawer of the cabinet assembly as shown in FIG. 7.

FIG. 9 is a side cross-sectional view of the drawer of the cabinet assembly as shown in FIG. 7.

FIG. 10 is a schematic operational view of the drawer of the cabinet assembly as shown in FIG. 9 in assembly.

FIG. 11 is a locally enlarged view of the cabinet assembly as shown in FIG. 2.

FIG. 12 is a partially exploded perspective view of the cabinet assembly as shown in FIG. 1.

FIG. 13 is a locally enlarged view of the cabinet assembly as shown in FIG. 12.

FIG. 14 is a locally enlarged view of the cabinet assembly as shown in FIG. 12.

FIG. 15 is a partially perspective view of the cabinet assembly as shown in FIG. 1.

FIG. 16 is a partially exploded perspective view of the cabinet assembly as shown in FIG. 15.

FIG. 17 is a partially exploded perspective view of the cabinet assembly as shown in FIG. 1.

FIG. 18 is a partially exploded perspective view of the cabinet assembly as shown in FIG. 1.

### DETAILED DESCRIPTION OF THE INVENTION

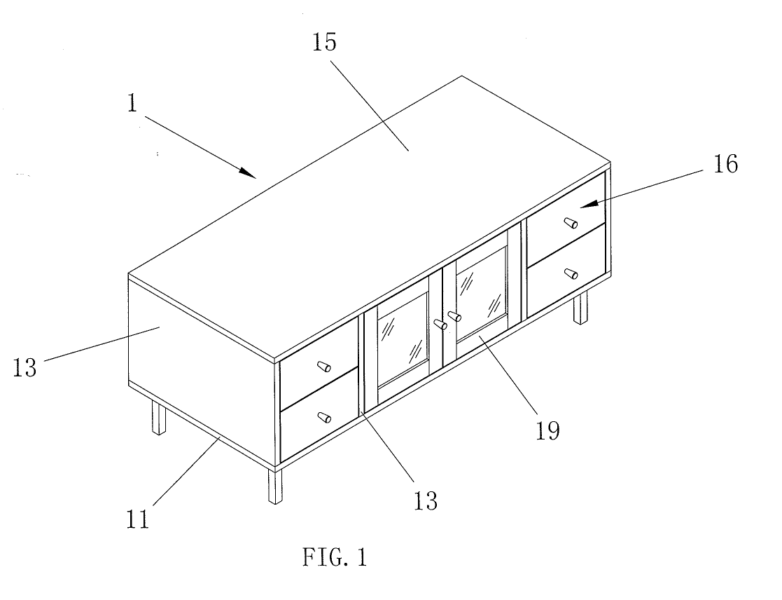

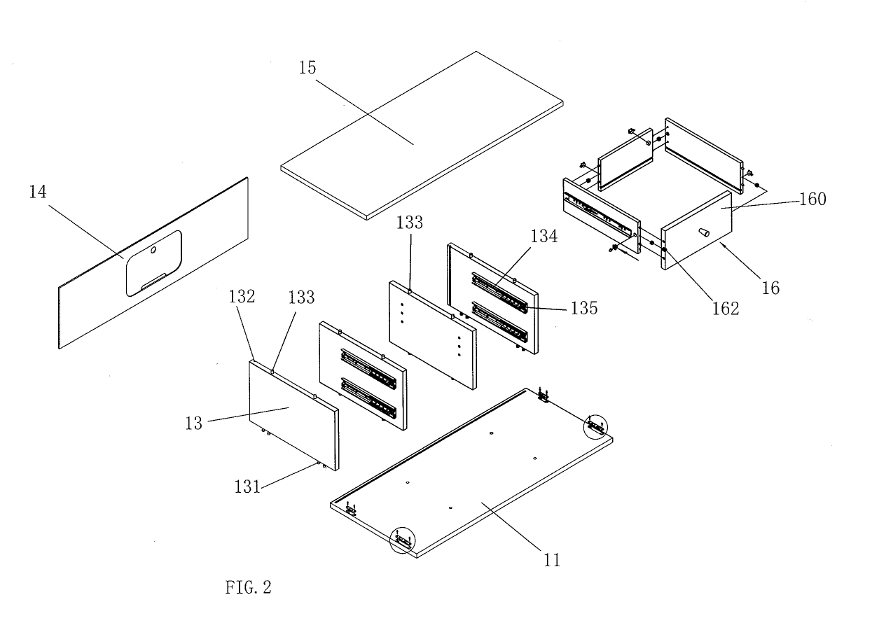

Referring to the drawings and initially to FIGS. 1 and 2, a cabinet assembly in accordance with the preferred embodiment of the present invention comprises a cabinet 1.

The cabinet 1 includes a bottom board 11, a plurality of upright connecting boards 13 detachably mounted on the bottom board 11, a top board 15 detachably mounted on the connecting boards 13 which are located between the bottom board 11 and the top board 15, a rear board 14 detachably mounted between two of the connecting boards 13 and located between the bottom board 11 and the top board 15, a plurality of drawers 16 detachably mounted between the connecting boards 13, and two front panels 19 pivotally and detachably mounted on two of the connecting boards 13 respectively and located between the bottom board 11 and the top board 15.

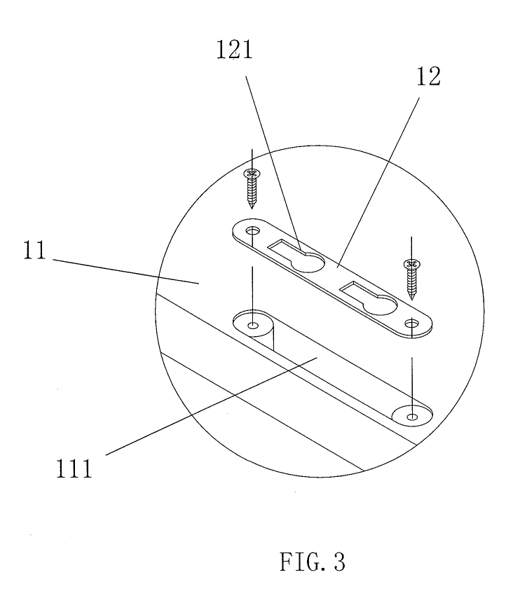

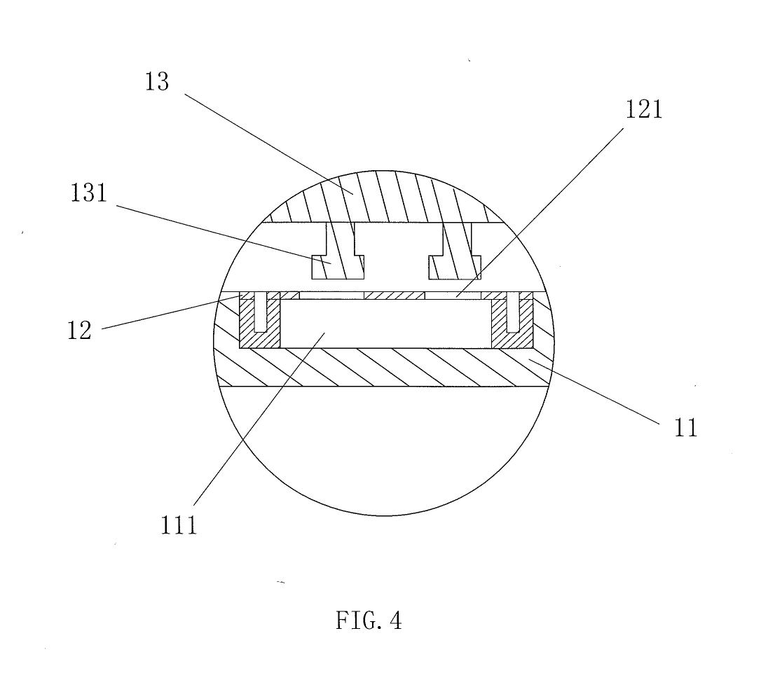

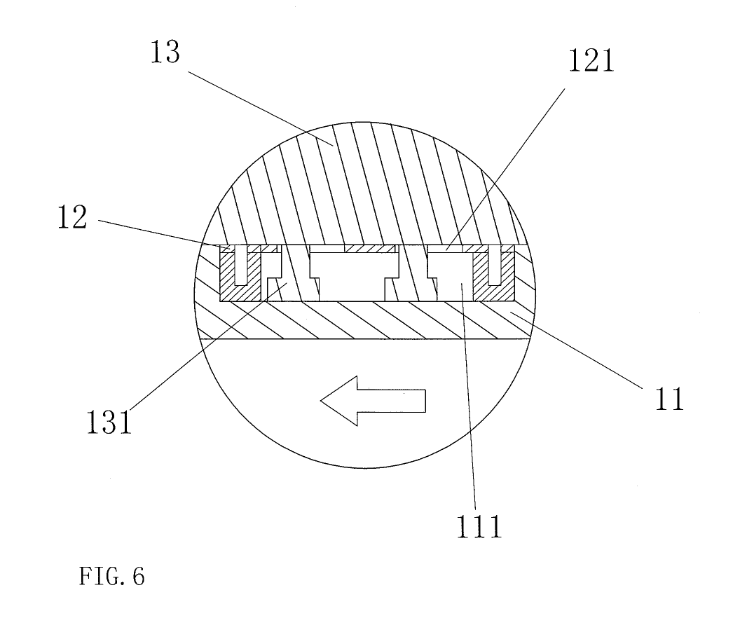

Referring to FIGS. 3-6 with reference to FIGS. 1 and 2, the bottom board 11 has a surface formed with a plurality of mounting holes 111 for mounting a plurality of fixing strips 12. Each of the fixing strips 12 has a surface formed with at least one stepped locking slot 121.

Each of the connecting boards 13 has a bottom provided with at least one stepped locking flange 131 inserted into and detachably locked in the locking slot 121 of the respective fixing strip 12 to lock each of the connecting boards 13 onto the bottom board 11. Each of the connecting boards 13 has a top provided with at least one fixing pin 133. Each of the connecting boards 13 has a surface formed with an upright retaining groove 132.

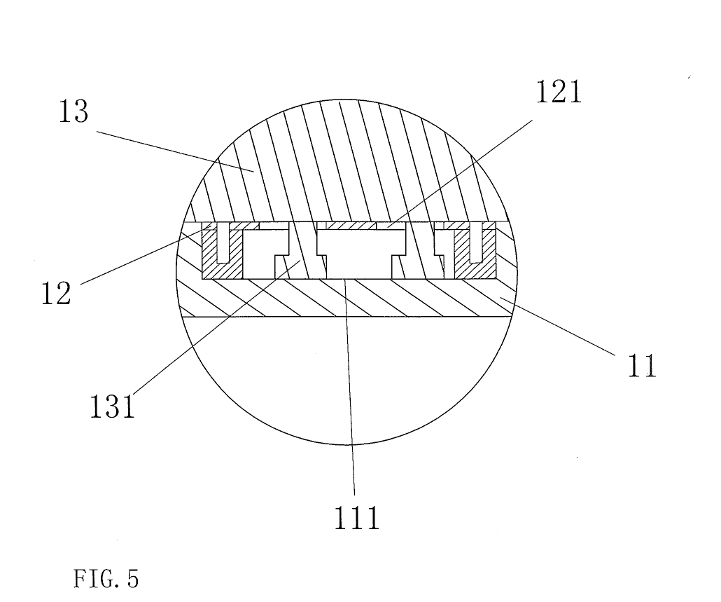

In assembly, the locking flange 131 of each of the connecting boards 13 is inserted into the locking slot 121 of the respective fixing strip 12 as shown in FIG. 5. Then, each of the connecting boards 13 is moved rearward relative to the respective fixing strip 12 to lock the locking flange 131 of each of the connecting boards 13 in the locking slot 121 of the respective fixing strip 12 so that each of the connecting boards 13 is locked onto the bottom board 11 by the respective fixing strip 12. Then, the rear board 14 is inserted between the retaining grooves 132 of two of the connecting boards 13 so that the rear board 14 is located between two of the connecting boards 13. Then, the top board 15 is fixed on the fixing pin 133 of each of the connecting boards 13 so that the top board 15 is locked onto each of the connecting boards 13.

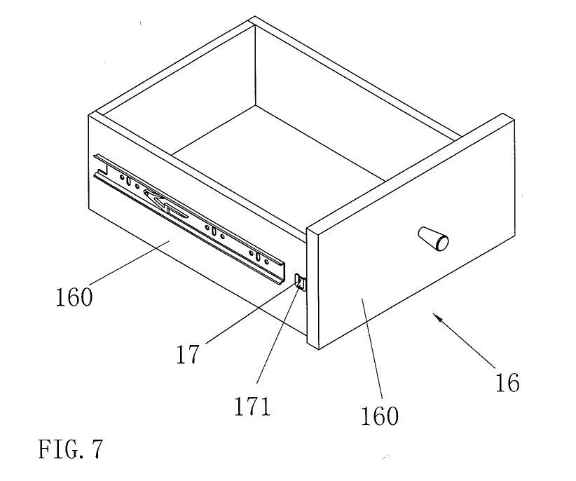

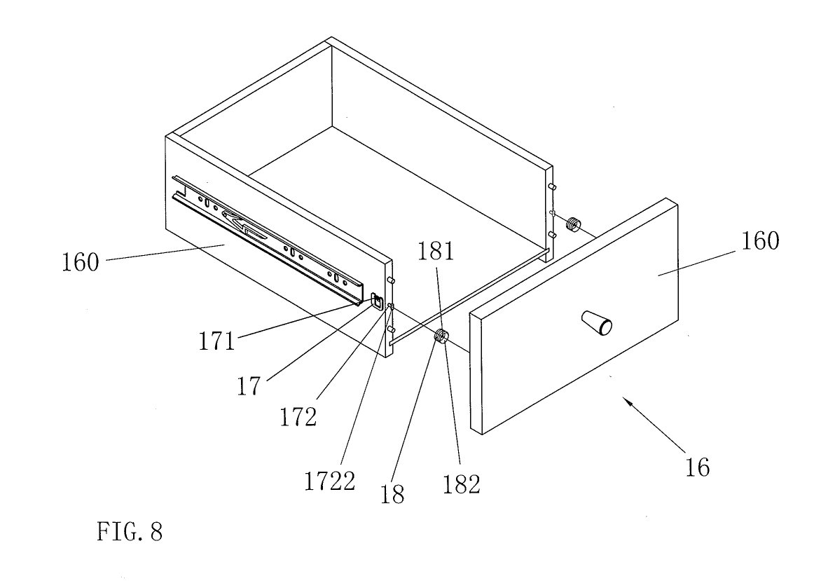

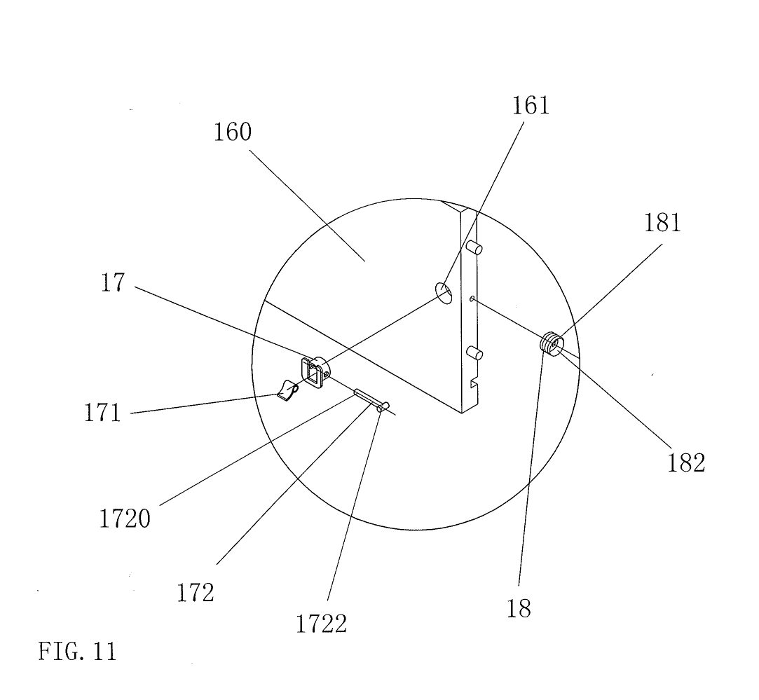

Referring to FIGS. 7-11 with reference to FIGS. 1 and 2, each of the drawers 16 includes a plurality connecting plates 160 connected with each other to form a substantially rectangular structure. One of the connecting plates 160 of each of the drawers 16 has two opposite ends each formed with a receiving hole 161 to receive an eccentric snap 17, a drive handle 171 and a stepped locking pin 172, and another of the connecting plates 160 of each of the drawers 16 has two opposite ends each formed with a screw bore 162 to screw a threaded tube 18.

The threaded tube 18 has a first end formed with a passage 181 and a second end formed with a locking space 182 connected to and having a diameter greater than that of the passage 181. The eccentric snap 17 is secured in the receiving hole 161 and has a hollow inside. The locking pin 172 has a first end 1720 rotatably mounted in the eccentric snap 17 and extended through the drive handle 171 and a stepped second end 1722 protruding outwardly from the respective connecting plate 160 of each of the drawers 16. The second end 1722 of the locking pin 172 is inserted through the passage 181 of the threaded tube 18 and is releasably locked in the locking space 182 of the threaded tube 18. The drive handle 171 is pivotally mounted on the eccentric snap 17 and secured on the first end 1720 of the locking pin 172 to rotate the locking pin 172 relative to the threaded tube 18.

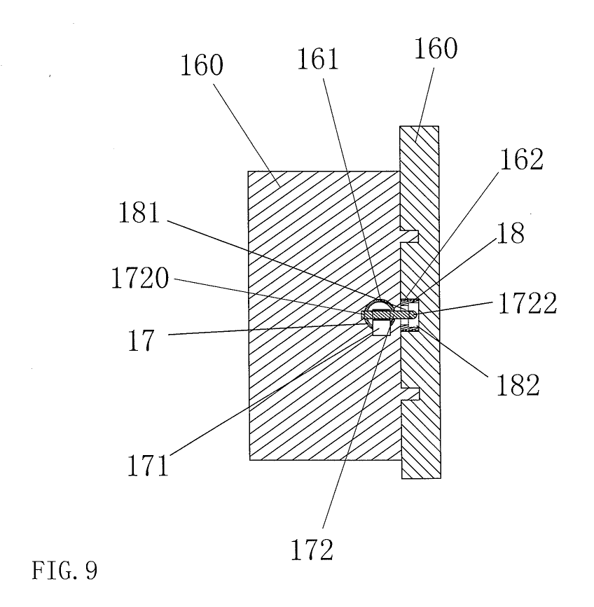

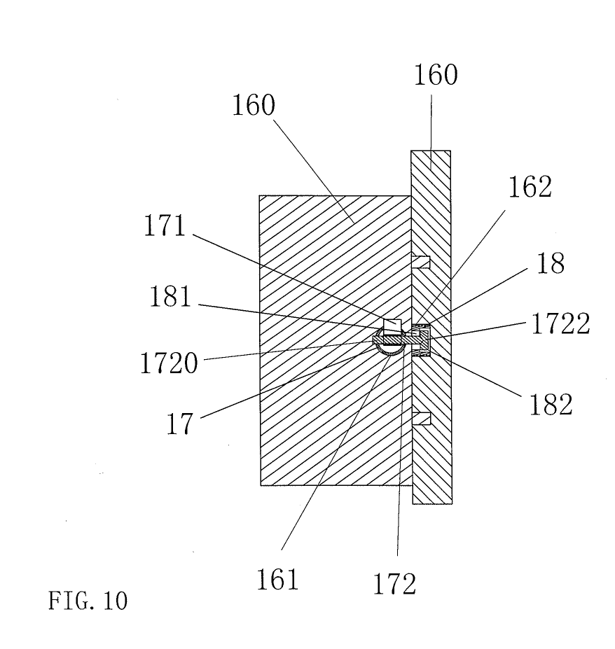

In assembly, the second end 1722 of the locking pin 172 is inserted through the passage 181 into the locking space 182 of the threaded tube 18 as shown in FIG. 9. Then, when the drive handle 171 is pivoted relative to the eccentric snap 17, the locking pin 172 is driven by the drive handle 171 to rotate relative to the threaded tube 18 so that the second end 1722 of the locking pin 172 is rotated through a determined angle and is locked in the locking space 182 of the threaded tube 18 as shown in FIG. 10. Thus, the connecting plates 160 of each of the drawers 16 are connected with each other by the locking pin 172 and the threaded tube 18.

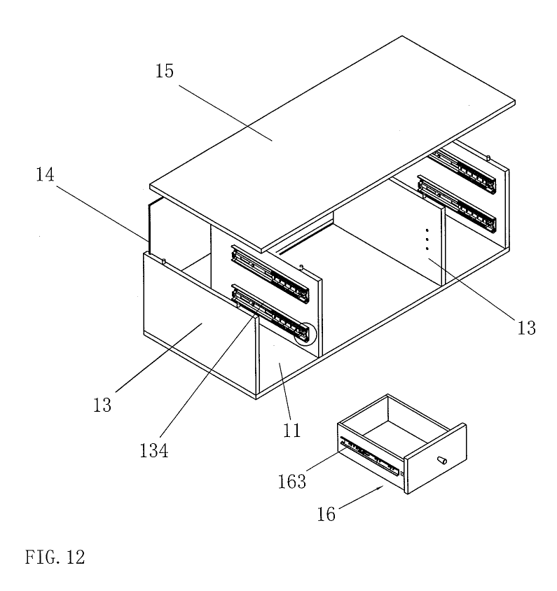

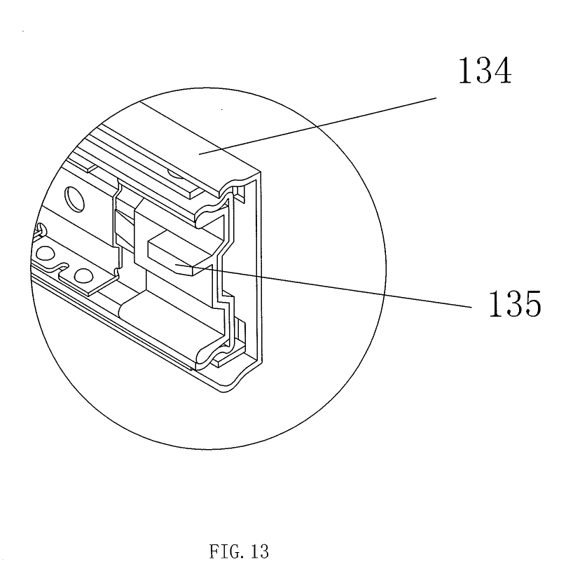

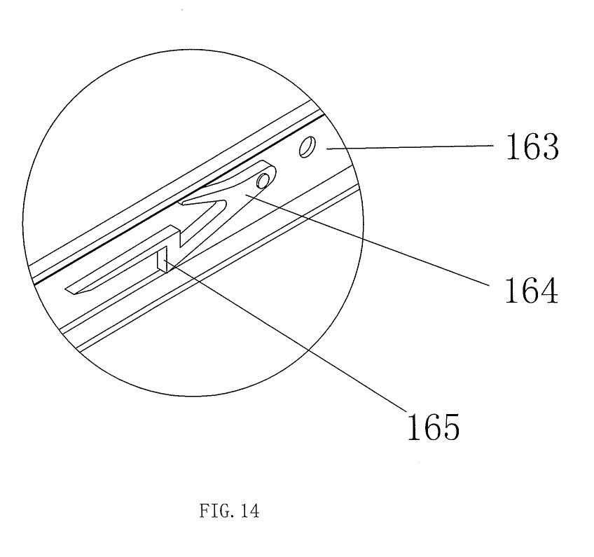

Referring to FIGS. 12-14 with reference to FIGS. 1 and 2, each of the connecting boards 13 is provided with at least one guide track 134. The guide track 134 of each of the connecting boards 13 has an end portion formed with a stop block 135. Each of the drawers 16 is provided with at least one sliding rail 163 slidably mounted on the guide track 134. Each of the drawers 16 is further provided with at least one stepped stop bar 164 pivotally mounted in the sliding rail 163. The stop bar 164 of each of the drawers 16 has a first end pivotally mounted on the sliding rail 163 and a second end formed with a limit recess 165 abutting the stop block 135 of the guide track 134.

In assembly, when the sliding rail 163 of each of the drawers 16 is inserted into the guide track 134 of each of the connecting boards 13, the stop bar 164 of each of the drawers 16 is pushed upward by the stop block 135 of the guide track 134 and is pivoted upward relative to the sliding rail 163 of each of the drawers 16 so that the stop bar 164 of each of the drawers 16 can pass through the stop block 135 of the guide track 134. After the limit recess 165 of the stop bar 164 aligns with the stop block 135 of the guide track 134, the stop bar 164 of each of the drawers 16 is driven downward by its gravity and is pivoted downward relative to the sliding rail 163 of each of the drawers 16 so that the limit recess 165 of the stop bar 164 can receive the stop block 135 of the guide track 134. In such a manner, when the sliding rail 163 of each of the drawers 16 is moved backward relative to the guide track 134 of each of the connecting boards 13, the limit recess 165 of the stop bar 164 is stopped by the stop block 135 of the guide track 134 to prevent the sliding rail 163 of each of the drawers 16 from being detached from the guide track 134 of each of the connecting boards 13.

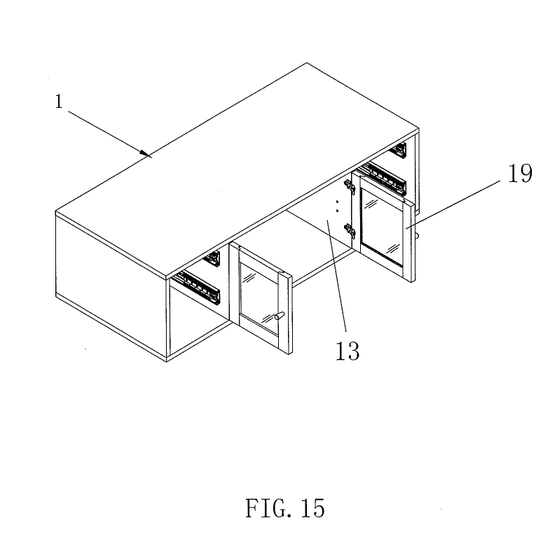

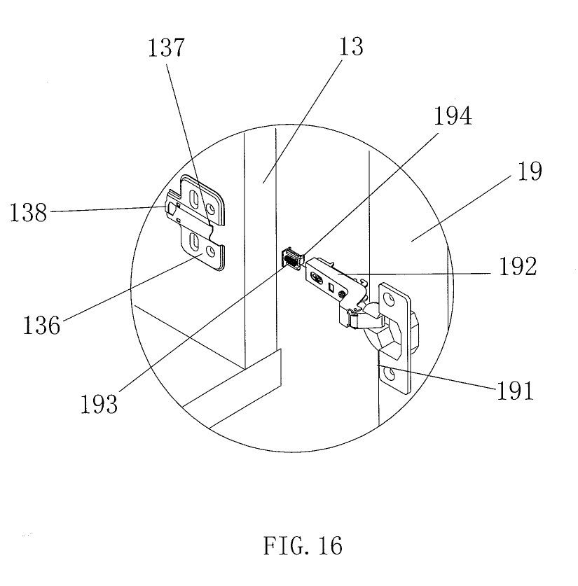

Referring to FIGS. 15 and 16 with reference to FIGS. 1 and 2, the cabinet 1 further includes two fixing plates 136 mounted on two of the connecting boards 13 respectively, and two pivot connections 191 each pivotally mounted on a respective one of the two front panels 19 and each detachably connected with a respective one of the two fixing plates 136 to attach the two front panels 19 to two of the connecting boards 13 respectively. Each of the two fixing plates 136 has a first end formed with an arcuate socket 137 and a second end formed with a positioning slot 138. Each of the two pivot connections 191 has a first end provided with a locking hook 192 locked in the socket 137 of the respective fixing plate 136 and a second end provided with an elastic snap 193 and a positioning block 194 each positioned in the positioning slot 138 of the respective fixing plate 136 so that each of the two pivot connections 191 is locked onto the respective fixing plate 136.

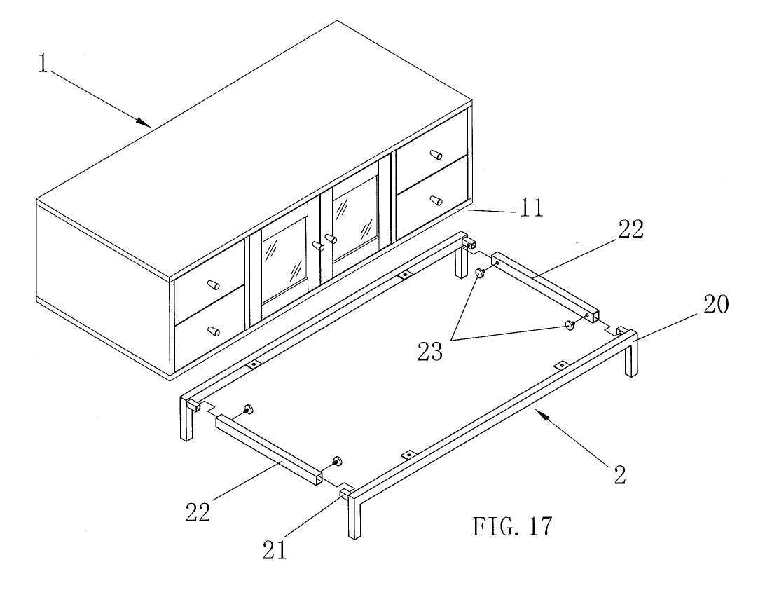

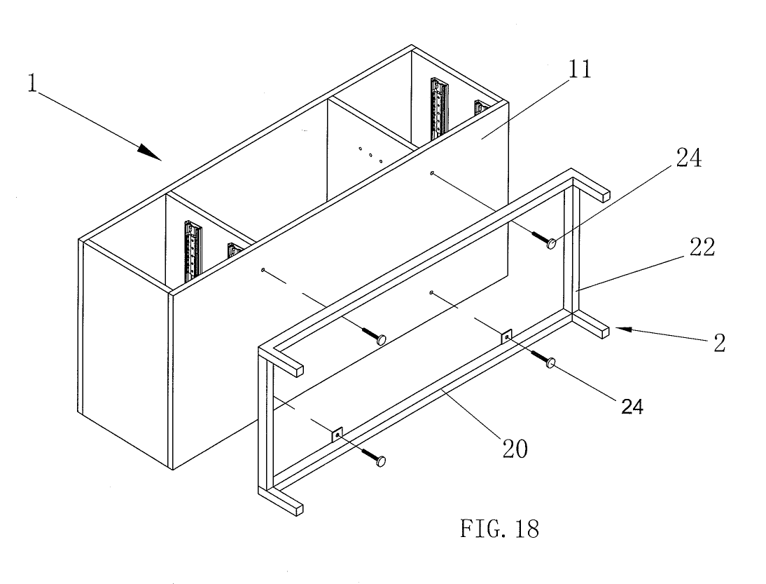

Referring to FIGS. 17 and 18 with reference to FIGS. 1 and 2, the cabinet assembly further comprises a bottom frame 2 mounted on a bottom of the cabinet 1 to support the cabinet 1. The bottom frame 2 includes two substantially inverted U-shaped support brackets 20 and two connecting sleeves 22 mounted between the two support brackets 20. Each of the two support brackets 20 of the bottom frame 2 has two opposite ends each provided with a transverse plug 21 inserted into and locked in a respective one of the two connecting sleeves 22 by a threaded locking knob 23 which is extended through the respective connecting sleeve 22 and screwed into the plug 21 of the respective support bracket 20. The bottom frame 2 is attached to the bottom board 11 of the cabinet 1 by a plurality of threaded fastening knobs 24 which are extended through the two support brackets 20 of the bottom frame 2 respectively and screwed into the bottom board 11 of the cabinet 1.

Accordingly, each of the cabinet 1 and the bottom frame 2 is assembled and disassembled individually so that the cabinet assembly can be assembled and disassembled easily and conveniently without using hand tools, thereby facilitating a user assembling and disassembling the cabinet assembly. In addition, each of the cabinet 1 and the bottom frame 2 can be detached completely so that the cabinet assembly has the minimum volume before assembly so as to decrease the cost of packaging, transportation and storage of the cabinet assembly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A cabinet assembly, comprising:
a cabinet including:
a bottom board;
a plurality of upright connecting boards detachably mounted on the bottom board;
a top board detachably mounted on the connecting boards which are located between the bottom board and the top board;
a rear board detachably mounted between two of the connecting boards and located between the bottom board and the top board;
a plurality of drawers detachably mounted between the connecting boards; and
two front panels pivotally and detachably mounted on two of the connecting boards respectively and located between the bottom board and the top board.

2. The cabinet assembly of claim 1, wherein
the bottom board has a surface formed with a plurality of mounting holes for mounting a plurality of fixing strips;
each of the fixing strips has a surface formed with at least one stepped locking slot;
each of the connecting boards has a bottom provided with at least one stepped locking flange inserted into and detachably locked in the locking slot of the respective fixing strip to lock each of the connecting boards onto the bottom board.

3. The cabinet assembly of claim 1, wherein
each of the connecting boards has a surface formed with an upright retaining groove;
the rear board is inserted between the retaining grooves of two of the connecting boards so that the rear board is located between two of the connecting boards.

4. The cabinet assembly of claim 1, wherein
each of the connecting boards has a top provided with at least one fixing pin;
the top board is fixed on the fixing pin of each of the connecting boards so that the top board is locked onto each of the connecting boards.

5. The cabinet assembly of claim 1, wherein
each of the drawers includes a plurality connecting plates connected with each other to form a substantially rectangular structure;
one of the connecting plates of each of the drawers has two opposite ends each formed with a receiving hole to receive an eccentric snap, a drive handle and a stepped locking pin;
another of the connecting plates of each of the drawers has two opposite ends each formed with a screw bore to screw a threaded tube;
the threaded tube has a first end formed with a passage and a second end formed with a locking space connected to and having a diameter greater than that of the passage;
the eccentric snap is secured in the receiving hole;
the locking pin has a first end rotatably mounted in the eccentric snap and a stepped second end protruding outwardly from the respective connecting plate of each of the drawers;
the second end of the locking pin is inserted through the passage of the threaded tube and is releasably locked in the locking space of the threaded tube;
the drive handle is pivotally mounted on the eccentric snap and secured on the first end of the locking pin to rotate the locking pin relative to the threaded tube.

6. The cabinet assembly of claim 5, wherein the eccentric snap has a hollow inside.

7. The cabinet assembly of claim 5, wherein the first end of the locking pin is extended through the drive handle.

8. The cabinet assembly of claim 1, wherein
each of the connecting boards is provided with at least one guide track;
the guide track of each of the connecting boards has an end portion formed with a stop block;
each of the drawers is provided with at least one sliding rail slidably mounted on the guide track;
each of the drawers is further provided with at least one stepped stop bar pivotally mounted in the sliding rail;
the stop bar of each of the drawers has a first end pivotally mounted on the sliding rail and a second end formed with a limit recess abutting the stop block of the guide track.

9. The cabinet assembly of claim 1, wherein the cabinet further includes:
two fixing plates mounted on two of the connecting boards respectively;
two pivot connections each pivotally mounted on a respective one of the two front panels and each detachably connected with a respective one of the two fixing plates to attach the two front panels to two of the connecting boards respectively.

10. The cabinet assembly of claim 9, wherein
each of the two fixing plates has a first end formed with an arcuate socket and a second end formed with a positioning slot;
each of the two pivot connections has a first end provided with a locking hook locked in the socket of the respective fixing plate and a second end provided with an elastic snap and a positioning block each positioned in the positioning slot of the respective fixing plate so that each of the two pivot connections is locked onto the respective fixing plate.

11. The cabinet assembly of claim 1, wherein the cabinet assembly further comprises a bottom frame mounted on a bottom of the cabinet to support the cabinet.

12. The cabinet assembly of claim 11, wherein the bottom frame includes:
two substantially inverted U-shaped support brackets;
two connecting sleeves mounted between the two support brackets.

13. The cabinet assembly of claim 12, wherein each of the two support brackets of the bottom frame has two opposite ends each provided with a transverse plug inserted into and locked in a respective one of the two connecting sleeves by a threaded locking knob which is extended through the respective connecting sleeve and screwed into the plug of the respective support bracket.

14. The cabinet assembly of claim 12, wherein the bottom frame is attached to the bottom board of the cabinet by a plurality of threaded fastening knobs which are extended through the two support brackets of the bottom frame respectively and screwed into the bottom board of the cabinet.
